(19) United States
(12) Patent Application Publication
(10) Pub. No.: US 2003/0229594 A1
(43) Pub. Date: Dec. 11, 2003

(54) Decoupled ingredient brand licensing method

(76) Inventor: Douglas A. Johnson, White Bear Lake, MN (US)

Correspondence Address: 3M INNOVATIVE PROPERTIES COMPANY, PO BOX 33427, ST. PAUL, MN, 55133-3427, US

(21) Appl. No.: 10/163,928

(22) Filed: Jun. 5, 2002

(51) Int. Cl. H04K 1/00; H04L 9/00; G06F 17/60

(52) U.S. Cl. 705/59

(57) ABSTRACT

Method of ingredient brand licensing comprising:

a) providing at least one ingredient to one or more resellers wherein the ingredient is used in the manufacture of at least one composite product and wherein the composite product or a functional product comprising or made utilizing the composite product is conveyed to one or more brand users;

b) receiving ingredient consideration in exchange for providing the ingredient;

c) providing a brand;

d) licensing the brand to one or more brand users wherein each brand user is licensed to associate the brand with a functional product wherein the functional product comprises or was made utilizing the composite product; and

e) receiving brand consideration in exchange for permitting use of the brand in association with the functional product wherein the brand consideration is received from a party other than the party from whom the ingredient consideration is received.

### FIELD OF INVENTION

The present invention relates to a method of ingredient brand licensing, i.e., the granting of license to use a brand in association with a product that comprises or was made using a specified ingredient.

### BACKGROUND

Ingredient brand licensing is a common business practice in which, for example, a brand holder sells a product, i.e., an ingredient, to a manufacturer who also obtains rights to use the brand holder's brand in connection with the manufacturer's product that comprises or is made with the ingredient. For example, companies selling protective materials or treatments for clothing to make them stain- and/or oil-resistant may also license the manufacturers of clothing or components thereof to use a brand of the protective materials or treatments of the supplier in connection with the clothing. This practice facilitates consumer identification with desired product features, e.g., stain- and/or oil-repellent fabrics and clothing. Ensuing customer awareness and demand for products comprising or made with the ingredient can increase demand among manufacturers for the brand holder's ingredient.

One problem with this approach is that the compensation which the brand holder can obtain is limited to the value of the brand as perceived by the manufacturer. In many instances, particularly where products are sold to consumers by parties other than the manufacturer, the manufacturer may perceive the brand to have a relatively lesser value than does the brand holder, even in the face of significant customer demand for the ingredient. In addition, although the consideration for the ingredient and brand may be separately provided for, they are not independent because both are negotiated between the same payer and recipient.

In the past it has been known to sell protective materials for use in fabrics and clothing to manufacturers of fabrics while simultaneously granting licenses to use a brand to designers and retailers of clothing made with such fabrics, commonly referred to as specifiers, though such licenses are not known to have been royalty-bearing. Desiring to create “pull through” interest in their protective materials, brand holders would grant non-royalty bearing licenses to specifiers who would in turn order fabrics and clothing made with the brand holder's ingredients from manufacturers.

### SUMMARY OF INVENTION

The present invention provides a novel method of ingredient brand licensing which may be practiced by a brand holder. By structuring the business model as decoupled or independent transactions for sale of ingredient(s) and licensing of brand rights, a brand holder can enhance the total consideration it receives for providing such ingredients and license rights. In addition, it can exploit its brand so as to more effectively enhance the exposure and strength of the brand in the marketplace.

In brief summary, the method of this invention comprises the following steps:

a) providing or specifying at least one ingredient to one or more resellers wherein the ingredient is used in the manufacture of at least one composite product and wherein the composite product or a functional product comprising or made utilizing the composite product is conveyed to one or more brand users;

b) receiving ingredient consideration in exchange for providing or specifying the ingredient;

c) providing a brand;

d) licensing the brand to one or more brand users wherein each brand user is licensed to associate the brand with a functional product that comprises or was made utilizing the composite product; and

e) receiving brand consideration in exchange for permitting use of the brand in association with the functional product wherein the brand consideration is received from a party other than the party from whom the ingredient consideration is received.

Through use of this method, a brand holder can maximize the value received for ingredient supply or specification and licensing of the brand. By decoupling the ingredient supply or specification and brand licensing actions, a brand holder can obtain full value for the ingredient as well as brand licensing components.

As used herein, a brand holder is a party holding rights to a brand which it can license to other parties, e.g., an owner of a brand or a licensee of a brand with the right to grant sublicenses to that brand. Such a party is also referred to herein as a business operator. The brand holder may be an individual person or any business entity, e.g., such as a corporation or partnership. Similarly, the other parties discussed herein, i.e., the reseller, distributors or other intermediaries, if any, manufacturer, if any, and the brand user may be an individual person or any business entity.

### BRIEF DESCRIPTION OF DRAWING

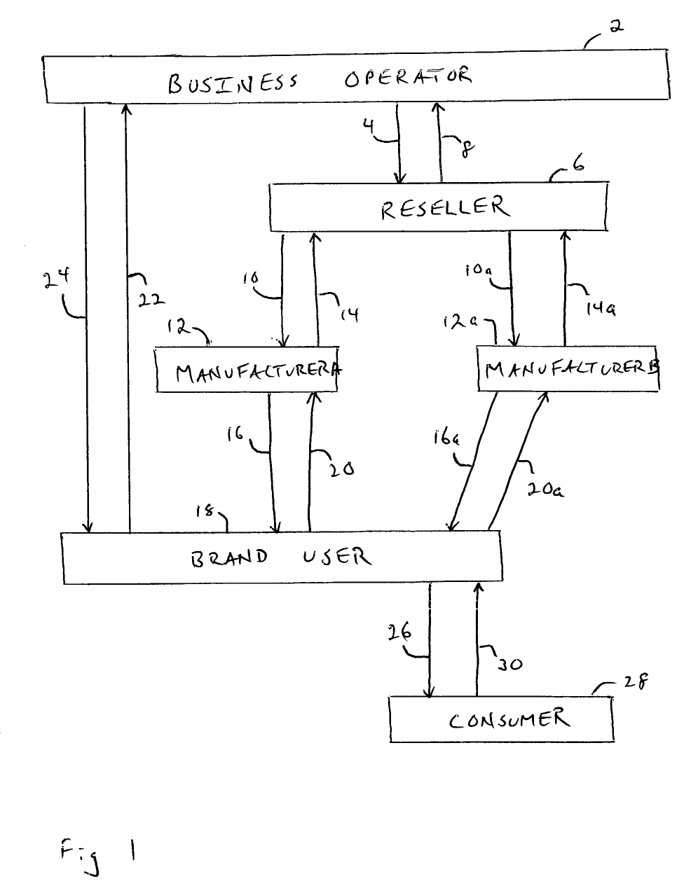

The invention will be further explained with reference to the drawing, wherein FIGS. 1-3 are schematic diagrams of illustrative methods of the invention.

These figures are idealized and are intended to be merely illustrative and non-limiting.

### DETAILED DESCRIPTION OF ILLUSTRATIVE EMBODIMENTS

Illustrative embodiments of the licensing method of the invention are discussed in detail below. The method is practiced by the business operator or brand holder.

As discussed above, the method of the invention comprises the following actions:

a) providing or specifying at least one ingredient to one or more resellers wherein the ingredient is used in the manufacture of at least one composite product and wherein the composite product or a functional product comprising or made utilizing the composite product is conveyed to one or more brand users;

b) receiving ingredient consideration in exchange for providing or specifying the ingredient;

c) providing a brand;

d) licensing the brand to one or more brand users wherein each brand user is licensed to associate the brand with a functional product wherein the functional product comprises or was made utilizing the composite product; and

e) receiving brand consideration in exchange for permitting use of the brand in association with the functional product wherein the brand consideration is received from a party other than the party from whom the ingredient consideration is received. Thus, under the present invention the business operator is providing two kinds of input at different points in the business channel and extracting consideration from two different points in the business channel. As used herein, a “composite product” means a product comprising or made with an ingredient provided by or specified by the business operator and a “functional product” is a product that (1) is conveyed by a brand user using brand rights licensed by the business operator and (2) comprises or is made using a composite product. An illustrative business channel would thus be for the business operator to convey ingredient (e.g., a protective surface coating for polycarbonate) to a reseller (e.g., plastics components distributor) who in turn conveys it to a manufacturer (e.g., a lens manufacturer) who uses the ingredient to make a composite product (e.g., an eyeglass lens) which the manufacturer conveys to another party (e.g., an eyeglasses vendor) who uses the composite product to make a functional product (e.g., eyeglasses having scratch resistant lenses) which is sold in association with the brand.

An illustrative embodiment of the invention is shown in FIG. 1. In this embodiment, the business operator 2 (i.e., brand holder) provides an ingredient 4 to reseller 6 in exchange for ingredient consideration 8. The reseller 6 then conveys 10 the ingredient (in original or converted form) to manufacturer 12 in exchange for consideration 14. The manufacturer 12 then produces a composite product which is conveyed 16 to a brand user 18 in exchange for consideration 20. The brand user 18 has received a license 22 for brand rights from the business operation 2 in exchange for brand consideration 24. The brand user 18 sells functional products 26 comprising or made with the composite products to consumers 28 using the brand. Typically the brand user receives consideration 30 from the consumer, e.g., purchase price. In this embodiment, the business operator provides an ingredient 4 and a license to brand rights 22 and receives ingredient consideration 8 and brand consideration 24.

The ingredient can be any product or material which the business operator wishes to use as the basis for use of its brand later in the business channel. In some embodiments, the ingredient is a product or material sold or distributed by the business operator. In other embodiments, the ingredient is a product which is specified by the business operator but obtained by the reseller from other sources, however, the business operator must receive consideration in connection with the reseller's obtaining the ingredient, e.g., a referral fee or other payment from the actual supplier. For example, use of the ingredient may be a trade secret for which the reseller pays the business operator a royalty while purchasing the ingredient elsewhere.

The ingredient may be something that is incorporated into a composite product, e.g., adhesive, protective materials, etc., or something that is used in the manufacture of a composite product, e.g., catalyst, sandpaper, etc.

The reseller to whom the business operator provides or specifies the ingredient may be a party who will use the ingredient itself to produce a composite product or may be an intermediary, e.g., a distributor. There may be one or more intermediaries between the reseller who obtains the ingredient from the business operator or its specified source and the party who manufactures the composite product. There may be one or more intermediaries between the business operator and the party who uses the ingredient in the manufacture of a composite product.

The business operator may provide or specify the ingredient(s) to one or more resellers. If desired, the business operator may provide or specify one or more ingredients which are basis for use of the brand by the brand user later in the supply chain.

The business operator receives ingredient consideration in exchange for providing or specifying the ingredient to the reseller. In a typical embodiment, the ingredient consideration is a monetary payment in exchange for providing or specifying the ingredient. In accordance with the invention, however, the ingredient consideration may be any consideration which the business operator and reseller agree to. Illustrative examples include monetary payment, credit against a debt owed, delivery of goods, delivery of services, and establishment of a debt. The ingredient consideration may be received in response to an invoice or bill issued by the business operator or may be received on other terms according to the terms agreed upon by the business operator and reseller. The ingredient consideration may be received by the business operator directly from the reseller or through an intermediary channel, e.g., a collections or invoicing agency.

In addition to the ingredient or specification of the ingredient, another key element that is provided by the business operator are rights to use the brand in association with defined products. The brand may be owned by the business operator or the business operator may simply hold rights, e.g., as a licensee, to grant sublicenses for use of the brand. The brand, may be any legally recognized word, mark, symbol, design, term, or combination of these used in the identification of a product, including any state or federally registered trademark or legally recognized common law brand right.

The brand user is a party to whom the business operator has granted a license to use the brand. In a typical embodiment it will be a wholesale or retail seller of goods including functional products. The brand user may manufacture functional products or obtain them from other sources.

As discussed above, the functional product is a product that (1) is conveyed by a brand user using brand rights licensed from the business operator and (2) comprises or is made using a composite product. In some instances, the functional product made consist essentially or even consist of the composite product.

The license to use the brand may include a number of terms as agreed between the business operator and brand user. Illustrative examples include specifications for appearance and presentation of the brand, e.g., color, position on packaging, position relative to other brands; specifications for the functional product(s); permitted market channels and segments; etc.

The license agreement between the business operator and brand user will preferably be a written license agreement so that the business operator can effectively license its brand rights while identifying and reducing risks.

The business operator may grant licenses to one or more brand users if desired. The terms of each license may differ if desired. Typically, any of the brand users may obtain a composite or functional product from one or more sources, including ingredient that has been provided to one or more resellers.

In the method of the invention, the reseller to whom the ingredient is provided or specified and from whom the business operator receives ingredient consideration and brand user to whom a license to use the brand is granted and from whom the business operator receives brand consideration are independent entities. By independent it is meant that one does not own a controlling-interest in the other nor is a controlling interest in both owned by a common party. In this way, the business operator is able to independently set and therefor maximize both the ingredient consideration and the brand consideration. In many embodiments, the independence of the reseller and brand user will be evident from the fact that there are multiple resellers to whom the ingredient or an ingredient specification is provided by the business operator and from whom a brand user may choose to obtain composite product or functional product. Similarly, in many embodiments, such independence will be evident from the fact that there are multiple brand users to whom a brand license has been granted and who will be obtaining composite product or functional product from channels including the one or more resellers. The existence of multiple resellers can provide to the brand user(s) and their customers the benefits of competition and having multiple sources of supply for composite product and/or functional product. The existence of multiple brand users can make available to the reseller(s) the benefits of a bigger potential market, again potentially benefiting the consumer.

Another advantage of having multiple brand users is that the business operator can obtain different rates of brand consideration from them. It will be understood that such differences might be based upon a number of factors including possibly the fact that different brand users use the brand in different market segments or different geographic areas, remit brand consideration in different forms (e.g., advertising placement v. monetary payment), sell different quantities of product in association with the brand, etc.

The business operator receives brand consideration in exchange for permitting the brand user to use the brand in association with a functional product. In a typical embodiment, the brand consideration is a monetary payment. In accordance with the invention, however, the brand consideration may be any consideration which the business operator and reseller agree to. Illustrative examples include monetary payment, credit against a debt owed, delivery of goods, delivery of services, and establishment of a debt. Perhaps most typically, the brand consideration may be received according to a schedule defined by the license agreement. It may be received on other terms according to the license terms agreed upon by the business operator and brand user. Any of a variety of known royalty structures and formulas may be used herein, including lump sum payments (single or series), volume-based royalties, etc. The brand consideration may be received by the business operator directly from the reseller or through an intermediary, e.g., a licensing agency.

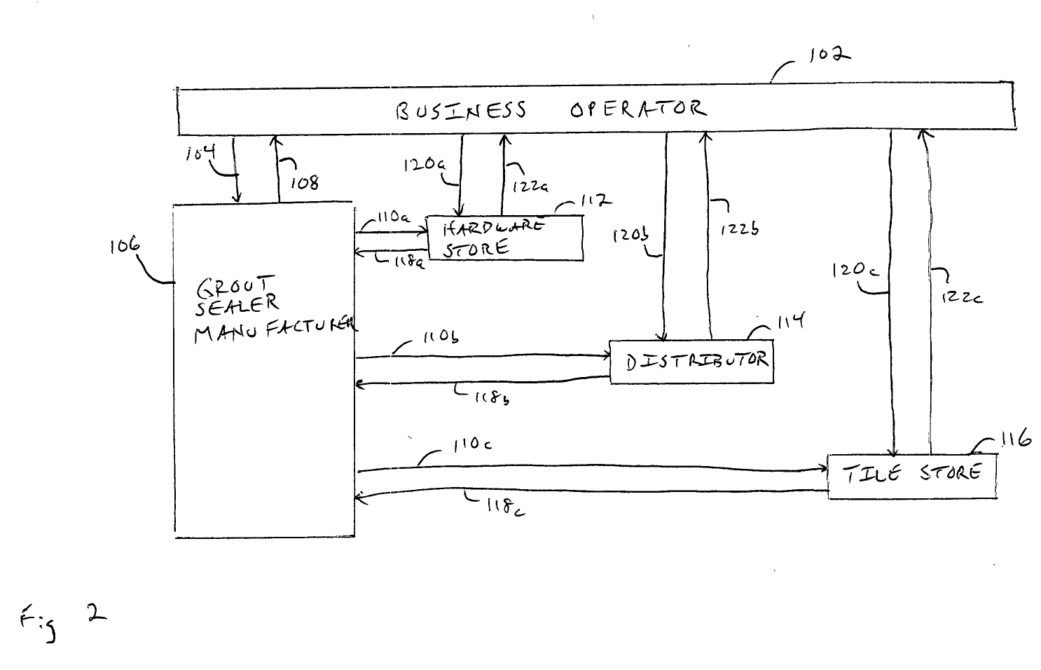

FIG. 2 illustrates another embodiment of the invention wherein in which the business operator 102 provides 104 to a grout sealer manufacturer 106 an ingredient for imparting improved cleanability characteristics to grout in exchange for ingredient consideration 108. In turn, the manufacturer 106 uses the ingredient to manufacture grout sealer, a composite product which it separately conveys 110a, 110b, and 110c to a hardware store 112, a tile supply distributor 114, and a tile store 116. Each of these brand users typically remits consideration (118a, 118b, and 118c, respectively) to the grout sealer manufacturer 106. In application of the method of the invention, business operator 102 has license agreements conveying (120a, 120b, and 120c, respectively) with each of the brand users in exchange for brand consideration (122a, 122b, and 122c, respectively). The method of the present invention will enable the business operator to negotiate different consideration with each of the brand users in view of their different stances in the tile grout sealer market.

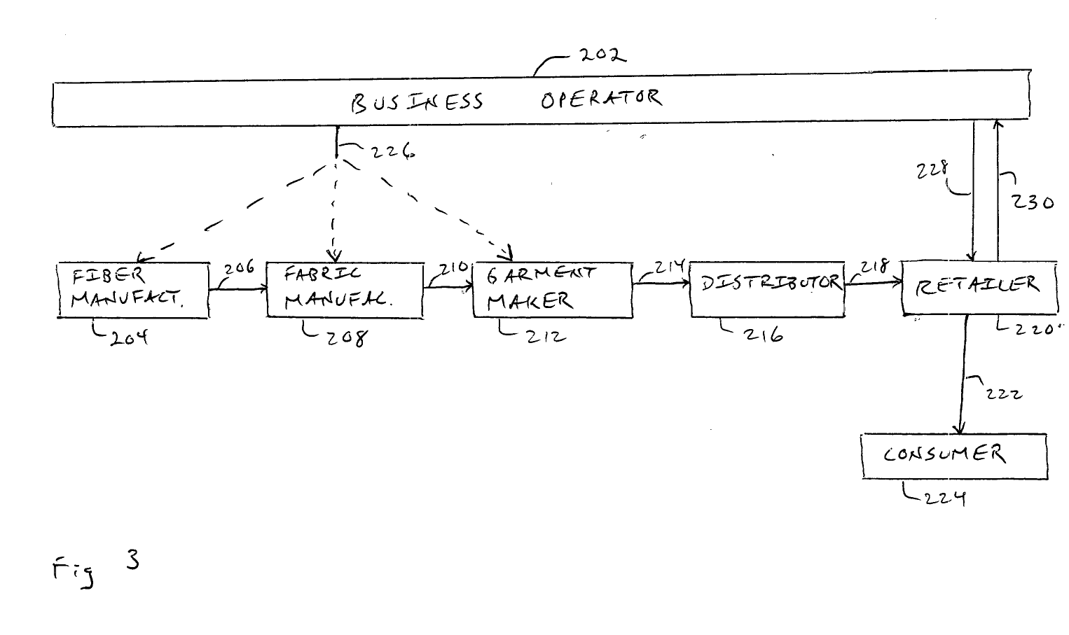

FIG. 3 illustrates another embodiment of the invention wherein in which the business operator 202 provides a protective material for use in garments to make them soil-, stain-, and water-resistant. In this business channel, a fiber manufacturer 204 manufactures fiber which is conveyed 206 to a fabric manufacturer 208 who manufactures fabric which is conveyed 210 to a garment maker 212 who manufactures garments which are conveyed 214 to a distributor 216 who conveys 218 the garments to a retailer 220 who conveys 222 the garments to consumers 224. It will be understood that this market may actually involve a multitude of manufacturers, distributors, and retailers, but only one of each is shown for convenience. In application of the method of the invention, the business operator provides 226 the protective material to at least one of the manufacturers (who is thus resellers as described herein) in exchange for ingredient consideration (not shown). In addition, the business operator has granted 228 to the retailer 220 a license to use a brand for which the retailer 220 remits brand consideration 230. Depending upon the nature of the ingredient(s), the business operator may provide or specify one or more ingredients to more than one of the manufacturers, for instance, compatible but different treatments for fibers and fabrics may be provided.

Further details of the invention are defined in the features of the claims.

Various modifications and alterations of this invention will become apparent to those skilled in the art without departing from the scope and spirit of this invention.

What is claimed is:

1. A method of doing business comprising:
a) providing or specifying at least one ingredient to one or more resellers wherein said ingredient is used in the manufacture of at least one composite product and wherein said composite product or a functional product comprising or made utilizing said composite product is conveyed to one or more brand users;
b) receiving ingredient consideration in exchange for providing or specifying said ingredient;
c) providing a brand;
d) licensing said brand to one or more brand users wherein each brand user is licensed to associate said brand with a functional product wherein said functional product comprises or was made utilizing said composite product; and
e) receiving brand consideration in exchange for permitting use of the brand in association with said functional product wherein said brand consideration is received from a party other than the party from whom said ingredient consideration is received.

2. The method of claim 1 wherein providing said ingredient to said reseller comprises providing said ingredient directly to a manufacturer who manufactures at least one composite product utilizing said ingredient.

3. The method of claim 1 wherein said reseller is a distributor who distributes said ingredient to one or more manufacturers who manufacture at least one composite product utilizing said ingredient.

4. The method of claim 1 wherein receiving said ingredient consideration comprises issuing a bill for providing said ingredient and collecting payment in response to said bill.

5. The method of claim 1 wherein said ingredient consideration comprises one or more forms of consideration from the group consisting of monetary payment, credit against a debt owed, delivery of goods, delivery of services, and establishment of a debt.

6. The method of claim 1 wherein said brand is a registered trademark.

7. The method of claim 1 wherein said brand user is granted a license to use said brand through a written license agreement.

8. The method of claim 7 wherein said license agreement provides for verifying that said functional product meets the qualifications for use of the brand, said qualifications comprising at least one of the qualifications in the group consisting of incorporation of said ingredient in said functional product, use of said ingredient in the manufacture of said functional product or a component thereof, use of said ingredient in conjunction with said functional product, specified quality standards, and specified brand usage standards.

9. The method of claim 1 wherein said brand is licensed to more than one brand user who receive licenses the terms of which differ in at least one of the following terms: length of term of license, formula for calculation of consideration, functional products in association with which the brand may be used, and market segments in which functional products may be distributed in association with the brand.

10. The method of claim 1 wherein said brand consideration is determined in correlation to the volume of said functional product.

11. The method of claim 1 wherein said brand consideration is determined in correlation to the market in which said functional product is distributed by said brand user.

12. The method of claim 1 wherein said manufacturer and said brand user are different parties.

13. The method of claim 1 wherein said brand user uses said brand as a secondary brand.

14. The method of claim 1 wherein said brand user uses said brand in product packaging.

15. The method of claim 1 wherein said brand user uses said brand in advertising.

16. The method of claim 1 wherein said brand consideration comprises one or more forms of consideration from the group consisting of monetary payment, credit against a debt owed, delivery of goods, delivery of services, and establishment of a debt.
